(19) United States
(12) Patent Application Publication
(10) Pub. No.: US 2017/0241493 A1
(43) Pub. Date: Aug. 24, 2017

(54) BRAKE DEVICE

(71) Applicant: SAF-HOLLAND GmbH, Bessenbach (DE)

(72) Inventor: Helmut Hock, Bessenbach (DE)

(73) Assignee: SAF-HOLLAND GmbH, Bessenbach (DE)

(21) Appl. No.: 15/503,607

(22) PCT Filed: Jul. 29, 2015
(86) PCT No.: PCT/EP2015/067334

§ 371 Date: Feb. 13, 2017

(30) Foreign Application Priority Data
Aug. 14, 2014 (DE) 10 2014 216 207.6

(51) Int. Cl. F16D 51/10; F16D 66/00

(52) U.S. Cl. CPC F16D 51/10; F16D 66/00; F16D 2066/003

(57) ABSTRACT

A brake device for braking a wheel, having a brake drum, a brake carrier for shifting a brake lining in order to press the brake lining against the brake drum, a sensor for sensing a rotational speed of the wheel, and an adjustment element configured to be coupled to the sensor and to spatially adjust the sensor.

### BACKGROUND OF THE INVENTION

The invention relates to a brake device for braking a wheel, in particular a drum brake.

Brake devices for braking the wheel of a vehicle, in particular a utility vehicle, are sufficiently known in the prior art. Drum brakes comprise a brake drum which rotates together with the wheel to be braked, and a brake lining carrier which can be lined with a brake lining and is pressed against the brake drum when the brake is activated. The brake lining carrier is pivotably mounted on a brake carrier and is shifted radially outward and pressed against the inner face of the rotating brake drum by means of an actuator unit, for example an expansion wedge.

In particular with respect to the monitoring of the state of movement of the vehicle, brake devices of the specified type frequently comprise a sensor for sensing or measuring the rotational speed of the wheel or of the brake drum. The sensor can be applied, in particular, in conjunction with an anti-lock brake system. A known embodiment comprises a sensor which is mounted on the brake carrier in a positionally fixed fashion, and a pole wheel which rotates together with the brake drum. The sensor comprises optical sensor means for determining the rotational speed of the pole wheel relative to the sensor.

If the sensor is not arranged in a positionally accurate fashion in the provided position, faults can occur during the measurement of the rotational speed. Usually, a fault message (referred to as an ABV fault) is triggered when such a displacement of the sensor occurs. In this case it is necessary to disassemble the brake drum or the wheel hub and shift the sensor again into the provided position. In particular, owing to the necessary disassembly of the brake device, this procedure is complex and therefore cost-intensive.

The invention is based on the object of specifying a brake device which permits rapid and simple adjustment of a sensor, in particular of an ABV sensor.

### SUMMARY OF THE INVENTION

According to the invention, the brake device comprises a brake drum, a brake carrier for shifting a brake lining in order to press the brake lining against the brake drum, and a sensor for sensing the rotational speed of the wheel. According to the invention, an adjustment element is provided which can be coupled to or engaged with the sensor and by means of which the sensor can be shifted or adjusted spatially. A basic concept of the invention can be considered that of coupling the sensor, in particular the housing of the sensor, to a mechanical adjustment element, with the result that the sensor can be shifted by mechanical activation or shifting of the adjustment element. In this context there is provision, in particular, that the sensor can be pressed on in the direction of a pole wheel by means of the adjustment element or transmission element. The adjustment element preferably permits a pressure force to be transmitted to the sensor, with the result that the sensor can be pressed, and as a result moved, by a pressure force transmitted via the adjustment element. The adjustment element is preferably rigid, with the result that a pressure force can be transmitted from the second end to the first end. The adjustment element preferably has a first end which is coupled to the sensor, and a second end which can be activated manually or by means of a tool. The adjustment element can be shifted altogether, in particular, without a change in shape, or without a significant change in shape, by a pressure force which is applied to the second end. By means of the adjustment element or transmission element it is possible to displace or shift the sensor back into its predefined position without disassembling the axle device, after said sensor has, under certain circumstances, moved away from the pole wheel, for example owing to vibrations on the vehicle.

The adjustment element is preferably accessible from outside the brake drum. In particular, when the brake device is mounted, the adjustment element can be accessible in such a way that the sensor can be adjusted spatially by means of the adjustment element.

According to one preferred embodiment of the invention, the adjustment element is embodied in the form of a hollow cylinder or sleeve. In this context, the adjustment element can, in particular, accommodate a cable element of the sensor. The cable element of the sensor preferably runs within the adjustment element here. It is particularly preferred that the cable element is led, together with the adjustment element, out of the brake device or the brake drum. The cable element can be, in particular, an electrically conductive cable or a cable wire.

According to a further preferred embodiment there is provision that the adjustment element forms an integral part of a cable sleeve. The, in particular electrical, cable element, for example for connecting the sensor to a signal processing unit, runs within the cable sleeve which is configured in a rigid fashion such that pressure forces can be transmitted from one end to the end adjoining the sensor. Therefore, the cable formed by the cable sleeve and the cable element running therein can be pressed at its end lying opposite the sensor and therefore the sensor can be shifted. The adjustment element can accordingly also be referred to as a dimensionally stable or stiff cable sleeve which transmits pressure forces.

A further preferred embodiment of the invention provides that the adjustment element has a length which corresponds to at least a distance of the sensor from an outer side of the brake device. The adjustment element preferably runs between the sensor and an outer side of the brake device. In this way, the adjustment element is accessible even when the brake device is mounted.

It is particularly preferred that the adjustment element projects out of an interior space of the brake drum. The adjustment element preferably runs in certain sections through an interior space of the brake device or of the brake drum and out of the interior space of the brake device or of the brake drum.

In a further preferred embodiment, the adjustment element is mounted in an opening in a closure plate of the brake device and/or projects through said opening. the closure plate can be, in particular, an element which bounds an interior space of the brake drum and protects it, for example, against soiling. The closure plate is preferably arranged at an open, axial end of the brake drum. Said closure plate can be a fixed element which can be embodied in an integral fashion with the brake carrier. The brake drum can be embodied here so as to be rotatable relative to the closure plate.

The adjustment element can be formed, for example, from metal and/or plastic. It is crucial that the adjustment element has a hardness or stiffness which permits the sensor to be shifted by means of the adjustment element. In contrast to customary cable sleeves, the adjustment element is therefore not randomly flexible but instead at least largely dimensionally stable. In particular, a hard plastic is preferred as the plastic.

Good activation of the adjustment element can be achieved if the adjustment element has a longitudinal axis which runs along a sensor longitudinal axis. The adjustment element is therefore preferably aligned with the sensor longitudinal axis. The essentially elongate and/or rotationally symmetrical adjustment element preferably runs coaxially with respect to the sensor longitudinal axis, wherein in the case of an optical sensor the sensor longitudinal axis runs, for example, in the direction of the beam path of the emitted beams.

It is preferred that the sensor can be plugged axially into a sensor mount. The invention then permits the sensor to be subsequently pressed or shifted into the sensor mount by means of the adjustment element if the sensor has become partially detached from the sensor mount or has shifted within it.

It is particularly preferred that the sensor can be adjusted in an axial direction, that is to say in the direction of the sensor longitudinal axis, by means of the adjustment element. In this way, there is no need for force to be diverted. The sensor can be pushed into the sensor mount, or pushed back therein, in a particularly simple manner, by pressure in the axial direction applied to the adjustment element.

It is particularly advantageous here if the adjustment element can be shifted along the axial direction and/or along the direction of the sensor longitudinal axis.

It is expedient if the adjustment element has indicator means, such as a mark, preferably in the region of its second end and, in particular, in the region of a part projecting out of the closure plate, by means of which indicator means the position or location of the adjustment element in the installed state can be recognized. It is therefore expediently possible to indicate visually whether the sensor or the adjustment element is in the fault position or in the operating position.

### BRIEF DESCRIPTION OF THE DRAWINGS

The invention will be described further below with reference to a preferred embodiment which is illustrated schematically in the appended figure. In the drawing:

FIG. 1 shows a cross-sectional view of a brake device according to the invention.

### DETAILED DESCRIPTION OF THE PREFERRED EMBODIMENTS

The brake device 10 comprises a brake drum 20 which is rotatably mounted on an axle element 12. The axle element 12 extends along a longitudinal axis which is characterized by the reference symbol 14 in the figure. The axle element 12 can be, for example, a fixed, that is to say non-rotating, axle of a vehicle, in particular of a utility vehicle.

In order to mount the brake drum 20 in a rotating fashion relative to the axle element 12, bearing devices 22, for example roller bearings, are provided. A wheel hub 26 is mounted on the bearing devices 22 in such a way that it can rotate relative to the axle element 12. The brake drum 20 is fixedly connected to the wheel hub 26, with the result that it can rotate together with the wheel hub 26 about the axle element 12. In order to connect the wheel hub 26 and brake drum 20 in a rotationally fixed fashion, attachment bolts 28 are provided. However, instead of the bolts 28, other attachment devices can also be provided.

The brake drum 20 is shaped in the form of a drum and comprises a drum ring 21 which extends in the axial direction and in the circumferential direction around the axle element 12 and surrounds or bounds an interior space 24 of the drum.

A brake carrier 30 which is fixedly connected to the axle element 12 is arranged in the interior space 24 of the drum, that is to say inside the brake drum 20. The brake carrier 30 bears a brake lining carrier 32 which cannot be seen in the sectional view and is indicated only schematically. The brake lining carrier 32 is provided on its face lying radially on the outside with brake linings 34 (also indicated only schematically) which, when the brake device 10 is activated, press against a circumferential face, lying on the inside, of the brake drum 20. In order to shift the brake lining carrier 32 radially, an activation device 36 is provided, for example an expansion wedge unit. The activation device 36 can usually be operated hydraulically and can for this purpose have a hydraulic cylinder.

The interior space 24 of the drum is closed off, in particular in order to protect against soiling, by a closure plate 40 which is arranged in a non-rotating fashion on the axle element 12. The closure plate 40 is located on an axial end face of the interior space 24 of the drum, which end face is turned toward the center of the vehicle in the mounted state of the brake device 10. The closure plate 40 can be considered to be part of the brake carrier 30 and can be embodied in an integral fashion therewith, for example as a cast part. The closure plate 40 is located, in particular, at an open end of the brake drum 20.

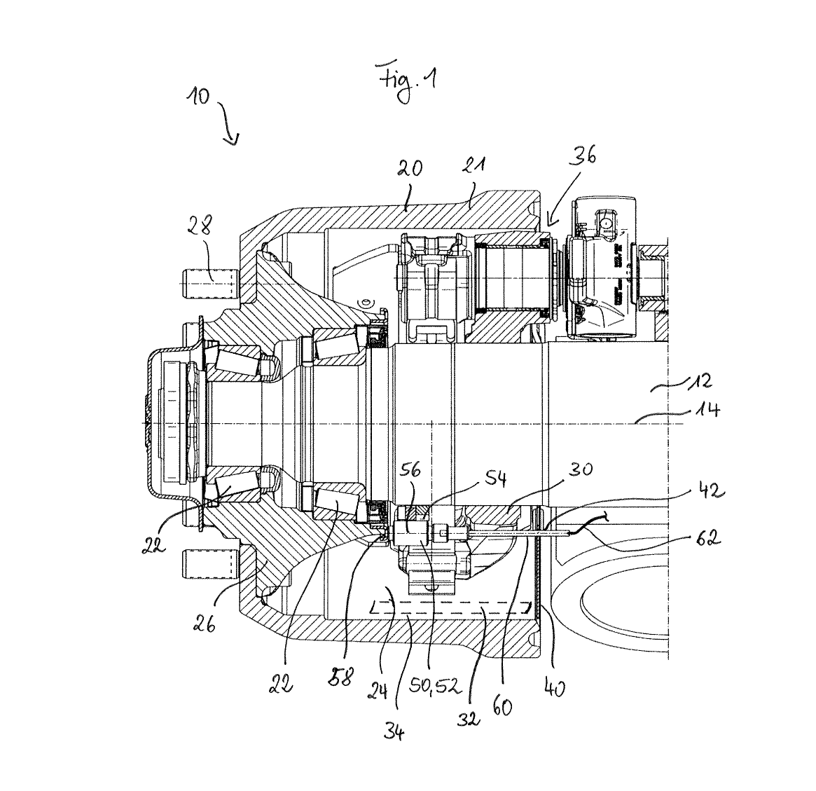

A pole wheel 58 is arranged on the rotating components of the brake device 10, in particular on the wheel hub 26. The pole wheel 58 is mounted so as to be rotatable relative to the axle element 12 and rotates together with the brake drum 20 or the wheel hub 26. Said pole wheel 58 comprises, in a basically known fashion, a multiplicity of webs and openings in the circumferential direction which can be detected by means of a sensor 50, in particular an optical sensor. The sensor 50 is for this purpose arranged in a positionally fixed fashion relative to the axle element 12 and is attached, for example, to the brake carrier 30. When the brake drum 20 rotates about the axle element 12, the sensor 50 can determine the rotational speed in a basically known fashion by measuring the speed of the grill rods and/or openings of the pole wheel 58 which pass the sensor 50. The sensor 50 comprises a sensor housing 52 which is accommodated in a sensor mount 54. A longitudinal axis or central axis of the sensor 50, which axis is referred to as a sensor longitudinal axis 56, runs in an axial direction of the axle element 12, in particular parallel to the longitudinal axis 14. The sensor 50 can be plugged into the sensor mount 54 along the sensor longitudinal axis 56 and can be pressed as far as a stop. The position of the sensor 50 which is illustrated in FIG. 1 is referred to as the operating position. In this position, it is possible to measure the rotational speed of the wheel or of the brake drum 20 around the axle element 12.

A functional fault can occur as a result of undesired shifting of the sensor 50 away from the pole wheel 58, that is to say in the direction toward the right in FIG. 1, and measurement of the rotational speed is therefore no longer possible. This position is referred to as fault position. In order to move the sensor 50 from its fault position to the operating position, an adjustment element 60 is provided which is connected to, or can be engaged with, the sensor 50, in particular the sensor housing 52. The adjustment element 60 runs out of the interior space 24 of the drum, starting from the sensor 50 arranged in the interior space 24 of the drum. In this context, said adjustment element 60 extends through the closure plate 40, in which an opening 42 is formed for this purpose. The adjustment element 60 is embodied in the form of a sleeve or rod and is, in particular, an elongate element which extends in the axial direction of the brake device 10, preferably parallel to the longitudinal axis 14. An electrical or optical cable element 62 preferably runs in the adjustment element 60, with the result that the adjustment element 60 forms a sheath of the cable element 62. The cable element 62 can project out of the adjustment element 60 at the end lying opposite the sensor 50. So that the sensor 50 can be pressed on in the direction of the pole wheel 58 via the adjustment element 60, the adjustment element 60 is configured in a stiff or rigid fashion and preferably runs along a straight line, in particular coaxially with respect to the sensor longitudinal axis 56. When the brake device 10 is mounted, the adjustment element 60 is accessible, in particular from outside the closure plate 40 which closes off the interior space 24 of the drum. For this purpose, the adjustment element preferably has a length which is greater than the distance of the sensor 50 from an axial boundary of the interior space 24 of the drum, in particular the closure plate 40. It is particularly preferred if the adjustment element 60 projects through the closure plate 40 and projects at least 5-15 mm out of the latter. This ensures reliable activation and, if appropriate, also visual monitoring from the outside of the brake device 10 which is bounded by the brake drum 20 and/or the closure plate 40. The adjustment element 60 can also be referred to as a stiff or rigid cable sleeve or additional sleeve or as a dimensionally stable or additional cable reinforcement. A fault (ABV fault) which is caused by a displacement of the sensor 50 can be eliminated with the additional sleeve or cable reinforcement without disassembling built-on parts.

### LIST OF REFERENCE NUMBERS

10 Brake device

12 Axle element

14 Longitudinal axis

20 Brake drum

21 Drum ring

22 Bearing device

24 Interior space of the drum

26 Wheel hub

28 Attachment bolt

30 Brake carrier

32 Brake lining carrier

34 Brake lining

36 Activation device

40 Closure plate

42 Opening

50 Sensor

52 Sensor housing

54 Sensor mount

56 Sensor longitudinal axis

58 Pole wheel

60 Adjustment element

62 Cable element

1.-13. (canceled)

14. A brake device for braking a wheel, comprising:
a brake drum;
a brake carrier configured to shift a brake lining with respect to the brake drum;
a sensor configured to detect a rotational speed of the wheel; and
an adjustment element configured to be engaged with the sensor to spatially shift the sensor, wherein the adjustment element comprises a sleeve and accommodates a cable element of the sensor.

15. The brake device as claimed in claim 14, wherein the adjustment element is configured to transmit a pressure force to the sensor.

16. The brake device of claim 15, wherein the adjustment element is rigid.

17. The brake device as claimed in claim 15, wherein the adjustment element forms an integral part of a cable sleeve.

18. The brake device as claimed in claim 17, wherein the adjustment element has a length which corresponds to at least a distance of the sensor from an outer side of the brake device.

19. The brake device as claimed in claim 18, wherein the adjustment element is accessible from outside the brake drum.

20. The brake device as claimed in claim 19, wherein the adjustment element projects out of an interior space of the brake drum.

21. The brake device as claimed in claim 20, wherein the adjustment element at least one of projects through and mounted in an opening in a closure plate of the brake device.

22. The brake device as claimed in claim 21, wherein the adjustment element comprises at least one of metal and plastic.

23. The brake device as claimed in claim 22, wherein the adjustment element has a longitudinal axis which runs along a sensor longitudinal axis.

24. The brake device as claimed in claim 23, wherein the sensor is configured to be plugged axially into a sensor mount.

25. The brake device as claimed in claim 24, wherein the sensor is configured to be adjusted in an axial direction by the adjustment element.

26. The brake device as claimed in claim 25, wherein the adjustment element includes an indicator in the region of an end pf the adjustment element.

27. The brake device as claimed in claim 26, wherein the indicator is in the region of the part projecting of the closure plate.

28. The brake device as claimed in claim 14, wherein the adjustment element forms an integral part of a cable sleeve.

29. The brake device as claimed in claim 14, wherein the adjustment element has a length which corresponds to at least a distance of the sensor from an outer side of the brake device.

30. The brake device as claimed in claim 14, wherein the adjustment element is accessible from outside the brake drum.

31. The brake device as claimed in claim 14, wherein the adjustment element projects out of an interior space of the brake drum.

32. The brake device as claimed in claim 14, wherein the adjustment element at least one of projects through and mounted in an opening in a closure plate of the brake device.

33. The brake device as claimed in claim 14, wherein the adjustment element comprises at least one of metal and plastic.

34. The brake device as claimed in claim 14, wherein the adjustment element has a longitudinal axis which runs along a sensor longitudinal axis.

35. The brake device as claimed in claim 14, wherein the sensor is configured to be plugged axially into a sensor mount.

36. The brake device as claimed in claim 14, wherein the sensor is configured to be adjusted in an axial direction by the adjustment element.

37. The brake device as claimed in claim 14, wherein the adjustment element includes an indicator in the region of an end of the adjustment element.
